(19) United States
(12) Patent Application Publication
(10) Pub. No.: US 2021/0191598 A1
(43) Pub. Date: Jun. 24, 2021

(54) Touch Sensing Device And Touch Sensing Method For Reducing Jitter

(71) Applicant: SILICON WORKS CO., LTD., Daejeon (KR)

(72) Inventor: Yang Been LIM, Daejeon (KR)

(73) Assignee: SILICON WORKS CO., LTD.

(21) Appl. No.: 17/110,752

(22) Filed: Dec. 3, 2020

(30) Foreign Application Priority Data
Dec. 18, 2019 (KR) 10-2019-0169790

(51) Int. Cl. G06F 3/041; G06F 3/0488

(52) U.S. Cl. CPC G06F 3/04186; G06F 3/04883

(57) ABSTRACT

A touch sensing device according to the present disclosure includes a touch coordinate calculation unit calculating a touch coordinate for a touch input and a touch coordinate correction unit calculating an output coordinate to be displayed on a display, wherein the touch coordinate correction unit includes a predicted coordinate calculator calculating a trend line on the basis of touch coordinates before a first time point and calculate a coordinate of a point, at which a first touch coordinate at the first time point is mapped on the trend line as a first predicted coordinate of the first time point, a corrected coordinate calculator calculating a first corrected coordinate by correcting the first touch coordinate using the first touch coordinate and a reference coordinate, and an output coordinate calculator calculating a first output coordinate of the first time point using the first predicted coordinate and the first corrected coordinate.

### CROSS-REFERENCE TO RELATED APPLICATIONS

This application claims the benefit of the Korean Patent Application No. 10-2019-0169790 filed on Dec. 18, 2019 which is hereby incorporated by reference as if fully set forth herein.

### FIELD

The present disclosure relates to a touch sensing device, and more particularly, to a touch sensing device capable of reducing jitter in touch drawing.

### BACKGROUND

With development into an information society, various demands are increasing for display devices for displaying images. Recently, various types of display devices such as a liquid crystal display (LCD) device or an organic light-emitting diode (OLED) display device are being utilized.

In recent years, display devices having a touch screen panel capable of detecting a touch input by a user's finger, a stylus pen, or the like have been widely used to break away from conventional input methods using buttons, a keyboard, a mouse, and the like. The display device having such a touch screen panel includes a touch sensing device for accurately detecting the presence or absence of a touch and a touch coordinate (a touch position).

When a user performs a line drawing on the above-described touch screen panel through a touch input, distortion may occur in a line due to jitter noise of a high-frequency component. In order to solve such a problem, methods of reducing the influence of jitter noise by correcting touch coordinates using a smoothing technique have been proposed. The smoothing technique reduces the influence of high-frequency noise in the touch coordinates so that the line drawn by the touch input may be smoothly expressed.

For example, in a case in which a smoothing technique is not applied to touch coordinates, a user's touch-drawing line is displayed to be meandering without smoothness due to jitter as illustrated in FIG. 1A. On the other hand, in a case in which the smoothing technique is applied to the touch coordinates, the jitter is reduced and thus the user's touch-drawing line is expressed as a smooth and natural line as illustrated in FIG. 1B.

The above-described smoothing technique corrects a current touch coordinate by assigning a weight to each of a previous touch coordinate and the current touch coordinate, and the jitter is reduced as the weight assigned to the previous touch coordinate is set to be higher.

However, as the weight assigned to the previous touch coordinate is set to be higher, the jitter is reduced, but there is a problem of occurring touch latency in which a touch trajectory is drawn to be delayed than an actual position of the touch. In particular, when a curved line is drawn, there is a problem in that a touch line drawn on a display is drawn inward than an actually drawn touch line.

### SUMMARY

The present disclosure is directed to providing a touch sensing device and a touch sensing method capable of improving adhesion feeling of a touch while reducing jitter of a drawn touch line.

The present disclosure is also directed to providing a touch sensing device and a touch sensing method capable of displaying a touch line that matches an actually drawn touch line.

According to an aspect of the present disclosure, there is provided a touch sensing device for reducing jitter including a touch coordinate calculation unit configured to calculate a touch coordinate for a touch input detected from touch electrodes, and a touch coordinate correction unit configured to calculate an output coordinate to be displayed on a display by correcting the touch coordinate calculated by the touch coordinate calculation unit, wherein the touch coordinate correction unit includes a predicted coordinate calculator configured to calculate a trend line on the basis of touch coordinates before a first time point and calculate a coordinate of a point, at which a first touch coordinate at the first time point is mapped on the trend line, as a first predicted coordinate of the first time point, a corrected coordinate calculator configured to calculate a first corrected coordinate by correcting the first touch coordinate using the first touch coordinate and a reference coordinate that is calculated on the basis of a second touch coordinate at a second time point before the first time point, and an output coordinate calculator configured to calculate a first output coordinate of the first time point using the first predicted coordinate and the first corrected coordinate.

According to another aspect of the present disclosure, there is provided a touch sensing method for reducing jitter including calculating a trend line on the basis of touch coordinates generated before a first time point, calculating a coordinate of a point at which a first touch coordinate at the first time point is mapped on the trend line as a first predicted coordinate of the first time point, calculating a first corrected coordinate by correcting the first touch coordinate using a reference coordinate and the first touch coordinate, the reference coordinate being calculated on the basis of a second touch coordinate of a second time point before the first time point, and calculating a first output coordinate at the first time point using the first predicted coordinate and the first corrected coordinate.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1A is a view illustrating a touch line composed of touch coordinates to which a smoothing technique is not applied;

FIG. 1B is a view illustrating a touch line composed of touch coordinates that are corrected using the smoothing technique;

FIG. 2 is a diagram illustrating a display system to which a touch sensing device according to one embodiment of the present disclosure is applied;

FIGS. 3A and 3B are schematic diagrams illustrating a configuration of a touch screen panel illustrated in FIG. 2;

FIG. 4 is a schematic block diagram illustrating a configuration of the touch sensing device illustrated in FIGS. 2, 3A, and 3B;

FIGS. 5A, 5B, 5C and 5D are conceptual views illustrating a method of generating an output coordinate by correcting a touch coordinate of a first time point by the touch sensing device according to the present disclosure;

FIG. 6A is a view illustrating a comparison between an actually drawn touch line and a touch line that is corrected using predicted coordinates;

FIG. 6B is a view illustrating a comparison between an actually drawn touch line and a touch line that is corrected using smoothing-based corrected coordinates;

FIG. 6C is a view illustrating a comparison between an actually drawn touch line and a touch line that is corrected according to the present disclosure; and

FIG. 7 is a flowchart illustrating a touch sensing method according to one embodiment of the present disclosure.

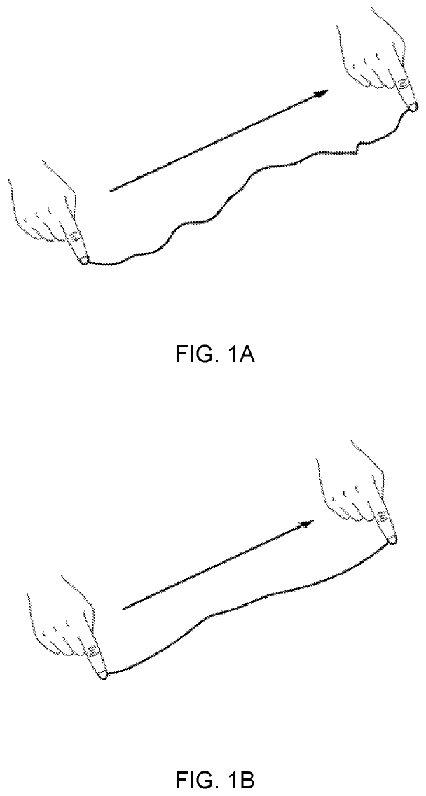

### DETAILED DESCRIPTION

In the specification, it should be noted that like reference numerals already used to denote like elements in other drawings are used for elements wherever possible. In the following description, when a function and a configuration known to those skilled in the art are irrelevant to the essential configuration of the present disclosure, their detailed descriptions will be omitted. The terms described in the specification should be understood as follows.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Further, the present disclosure is only defined by scopes of claims.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted.

In a case where ‘comprise’, ‘have’, and ‘include’ described in the present specification are used, another part may be added unless ‘only˜’ is used. The terms of a singular form may include plural forms unless referred to the contrary.

In construing an element, the element is construed as including an error range although there is no explicit description.

In describing a position relationship, for example, when a position relation between two parts is described as ‘on˜’, ‘over˜’, ‘under˜’, and ‘next˜’, one or more other parts may be disposed between the two parts unless ‘just’ or ‘direct’ is used.

In describing a time relationship, for example, when the temporal order is described as ‘after˜’, ‘subsequent˜’, ‘next˜’, and ‘before’, a case which is not continuous may be included unless ‘just’ or ‘direct’ is used.

It will be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

An X axis direction, a Y axis direction, and a Z axis direction should not be construed as only a geometric relationship where a relationship therebetween is vertical, and may denote having a broader directionality within a scope where elements of the present disclosure operate functionally.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item.

Features of various embodiments of the present disclosure may be partially or overall coupled to or combined with each other, and may be variously inter-operated with each other and driven technically as those skilled in the art can sufficiently understand. The embodiments of the present disclosure may be carried out independently from each other, or may be carried out together in co-dependent relationship.

Hereinafter, embodiments of the present specification will be described in detail with reference to the accompanying drawings.

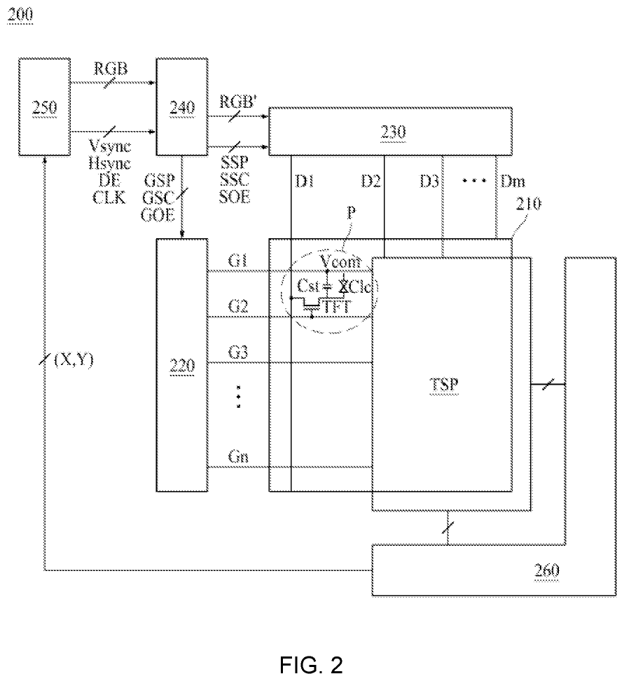

FIG. 2 is a diagram illustrating a display system to which a touch sensing device according to one embodiment of the present disclosure is applied.

As illustrated in FIG. 2, a display system 200 includes a display panel 210, a gate driver 220, a data driver 230, a timing controller 240, a host system 250, a touch screen panel TSP, and a touch sensing device 260.

The display panel 210 includes a plurality of gate lines G1 to Gn and a plurality of data lines D1 to Dm, which are arranged to intersect each other and define a plurality of pixel regions, and a pixel P provided in each of the plurality of pixel regions. The plurality of gate lines G1 to Gn may be extended in a transverse direction and the plurality of data lines D1 to Dm may be extended in a longitudinal direction, but the present disclosure is not necessarily limited thereto.

In one embodiment, the display panel 210 may be a liquid crystal display (LCD) panel. When the display panel 210 is an LCD panel, the display panel 210 includes thin-film transistors (TFTs) and liquid crystal cells connected to the TFTs, which are formed in the pixel regions defined by the plurality of gate lines G1 to Gn and the plurality of data lines D1 to Dm.

The TFT transmits a source signal supplied through the data lines D1 to Dm to the liquid crystal cell in response to a scan pulse supplied through the gate lines G1 to Gn.

The liquid crystal cell is composed of a common electrode and a sub-pixel electrode, which is connected to the TFT, facing each other with a liquid crystal therebetween, and thus may be equivalently expressed as a liquid crystal capacitor Clc. The liquid crystal cell includes a storage capacitor Cst connected to the gate line of a previous stage in order to maintain a voltage corresponding to the source signal charged in the liquid crystal capacitor Clc until a voltage corresponding to a next source signal is charged.

Meanwhile, the pixel regions of the display panel 210 may include red (R), green (G), blue (B), and white (W) subpixels. In one embodiment, each of the subpixels may be repeatedly formed in a row direction or formed in a matrix form of 2×2. In this case, a color filter corresponding to each color is disposed in each of the red (R), green (G), and blue (B) subpixels, but a separate color filter is not disposed in the white (W) subpixel. In one embodiment, the red (R), green (G), blue (B), and white (W) subpixels may be formed to have the same area ratio, but may also be formed to have different area ratios.

Although the display panel 210 has been described as being an LCD panel in the above-described embodiment, in other embodiments, the display panel 210 may also be an organic light-emitting diode (OLED) display panel.

The gate driver 220 includes a shift register configured to sequentially generate a scan pulse, that is, a gate high pulse, in response to a gate control signal GCS from the timing controller 240. In response to the scan pulse, the TFT is turned on.

The gate driver 220 may be disposed on one side of the display panel 210, for example, on a left side of the display panel 210 as illustrated in the drawing, but in some cases, may be disposed on one side and the other side of the display panel 210 which are opposite to each other, for example, both left and right sides thereof. The gate driver 220 may include a plurality of gate driver integrated circuits (ICs) (not shown). The gate driver 220 may be formed in the form of a tape carrier package on which the gate driver ICs are mounted, but the present disclosure is not necessarily limited thereto, and the gate driver ICs may be directly mounted on the display panel 210.

The data driver 230 converts a digital image signal RGB′ transmitted from the timing controller 240 into an analog source signal and outputs the analog source signal to the display panel 210. In more detail, the data driver 230 outputs the analog source signal to the data lines D1 to Dm in response to a data control signal DCS transmitted from the timing controller 240.

The data driver 230 may be disposed on one side of the display panel 210, for example, on an upper side of the display panel 210, but in some cases, may be disposed on one side and the other side of the display panel 210 which are opposite to each other, for example, both upper and lower sides thereof. In addition, the data driver 230 may be formed in the form of a tape carrier package on which source driver ICs are mounted, but the present disclosure is not necessarily limited thereto.

In one embodiment, the data driver 230 may include a plurality of source driver ICs (not shown) configured to convert a digital image signal transmitted from the timing controller 240 into an analog source signal and output the analog source signal to the display panel 210.

The timing controller 240 receives various timing signals including a vertical synchronization signal Vsync, a horizontal synchronization signal Hsync, a data enable signal DE, a clock signal CLK, and the like from the host system 250, and generates the data control signal DCS for controlling the data driver 230 and the gate control signal GCS for controlling the gate driver 220. In addition, the timing controller 240 receives an image signal RGB from the host system 250, converts the received image signal RGB into the image signal RGB′ in a form that can be processed by the data driver 230, and outputs the converted image signal RGB′.

In one embodiment, the data control signal DCS may include a source start pulse SSP, a source sampling clock SSC, a source output enable signal SOE, and the like, and the gate control signal GCS may include a gate start pulse GSP, a gate shift clock GSC, a gate output enable-signal GOE, and the like.

Here, the source start pulse controls a data sampling start timing of the plurality of source driver ICs which configure the data driver 230. The source sampling clock is a clock signal which controls a sampling timing of data in each of the source driver ICs. The source output enable signal controls an output timing of each of the source driver ICs.

The gate start pulse controls an operation start timing of the plurality of gate driver ICs which configure the gate driver 220. The gate shift clock is a clock signal which is commonly input to one or more gate driver ICs and controls a shift timing of a scan signal (gate pulse). The gate output enable-signal designates timing information of one or more gate driver ICs.

The host system 250 may be implemented as one among a navigation system, a set-top box, a digital video disk (DVD) player, a Blu-ray player, a personal computer (PC), a home theater system, a broadcast receiver, and a phone system. The host system 250 includes a system-on-chip (SoC) with a built-in scaler to convert the digital image signal RGB of an input image into a format suitable for display on the display panel 210. The host system 250 transmits the digital image signal RGB and the timing signals to the timing controller 240. In addition, the host system 250 analyzes touch coordinates X and Y input from the touch sensing device 260, and outputs the touch coordinate on the display panel 210 in a form of lines or executes an application program associated with coordinates generated by a user's touch.

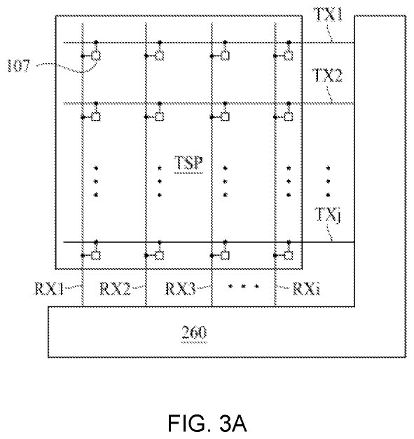

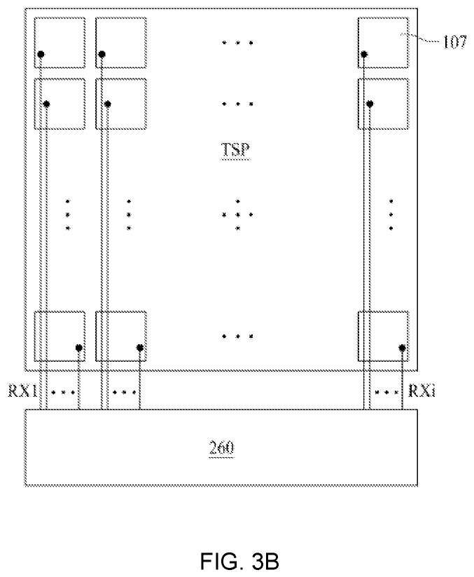

The touch screen panel TSP is where the user's touch is input, and in one embodiment, as illustrated in FIG. 3A, the touch screen panel TSP may include touch driving lines TX1 to TXj (where, j is a natural number greater than or equal to 2) through which a touch driving signal is transmitted, a plurality of touch electrodes 107, and touch sensing lines RX1 to RXi (where, i is a natural number greater than or equal to 2) through which voltages (or charges) of the touch electrodes 107 are transmitted. In this case, each of the touch electrodes 107 includes a mutual capacitor. The touch sensing lines RX1 to RXi may refer to sensing lines of the touch screen panel TSP. In one embodiment, the touch screen panel TSP may be implemented in a form embedded in the display panel 210. For example, the touch screen panel TSP may be disposed on the display panel 210 in an on-cell manner or may be disposed in the display panel 210 an in-cell manner.

In FIG. 3A, the touch screen panel TSP is illustrated as being a mutual-capacitance-type touch screen panel including the touch driving lines TX1 to TXj and the touch sensing lines RX1 to RXi. However, the present disclosure is not limited thereto, and a self-capacitance-type touch screen panel may be applied as illustrated in FIG. 3B. In the self-capacitance-type touch screen panel, the supply of a touch driving signal and the reception of a change in capacitance caused by a user's touch or a touch by a stylus pen are implemented through one of the touch sensing lines RX1 to RXi.

Referring to FIG. 2 again, the touch sensing device 260 senses a touch generated on the touch screen panel TSP. In one embodiment, the touch sensing device 260 drives the touch electrodes 107 by supplying the touch driving signal to the touch electrodes 107 through the touch driving lines TX1 to TXj, and senses a change in capacitance, which occurs when the touch electrodes 107 are touched, through the touch sensing lines RX1 to RXi.

The touch sensing device 260 calculates touch raw data TRD on the basis of the obtained capacitance change, and calculates a touch coordinate on the basis of the calculated touch raw data.

In particular, the touch sensing device 260 according to the present disclosure may correct the touch coordinate and transmit the corrected touch coordinate to the host system 250 as final output coordinates X and Y in order to improve an adhesion feeling of a touch while reducing jitter during touch sensing.

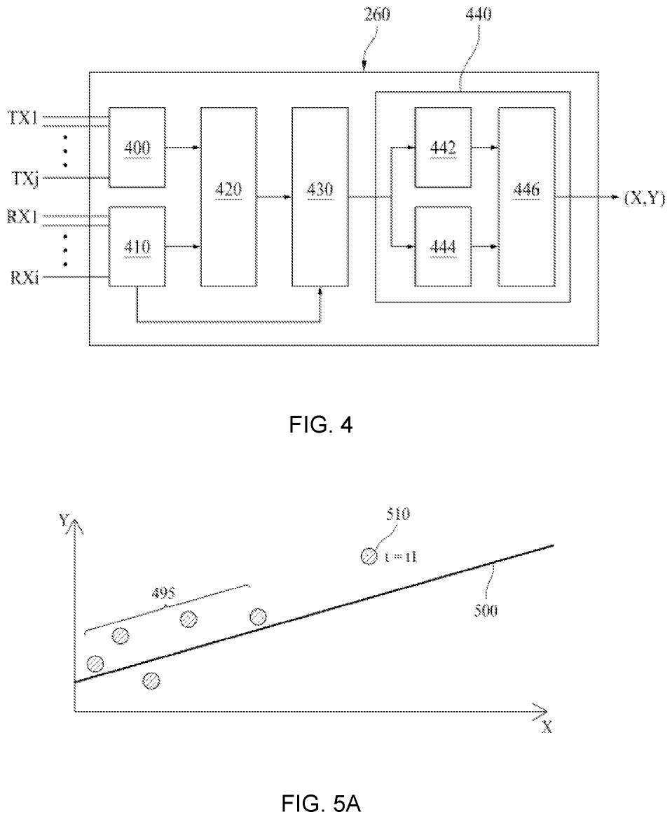

Hereinafter, a configuration of the touch sensing device according to the present disclosure will be described in more detail with reference to FIG. 4.

FIG. 4 is a schematic block diagram illustrating the configuration of the touch sensing device according to one embodiment of the present disclosure. As illustrated in FIG. 4, the touch sensing device 260 according to one embodiment of the present disclosure includes a touch driving unit 400, a touch sensing unit 410, a touch controller 420, a touch coordinate calculation unit 430, and a touch coordinate correction unit 440. The touch driving unit 400, the touch sensing unit 410, the touch controller 420, the touch coordinate calculation unit 430, and the touch coordinate correction unit 440 may be integrated into one read-out IC (ROIC).

The touch driving unit 400 selects a touch driving channel through which a touch driving pulse is output under the control of the touch controller 420, and supplies the touch driving pulse to the touch driving lines TX1 to TXj connected to the selected touch driving channel.

The touch sensing unit 410 selects a touch sensing channel through which the voltages of the touch electrodes are received under the control of the touch controller 420, and receives the voltages of the touch electrodes through the touch sensing lines RX1 to RXj connected to the selected touch sensing channel. The touch sensing unit 410 samples the voltages of the touch electrodes received through the touch sensing lines RX1 to RXi and accumulates the sampled voltages in an integrator (not shown). The touch sensing unit 410 converts the voltages accumulated in the integrator into touch raw data TRD, which is digital data, by inputting the accumulated voltages to an analog-to-digital converter (ADC) (not shown) and then outputs the touch raw data TRD.

The touch controller 420 generates a touch driving setup signal for setting the touch driving channel through which the touch driving pulse is to be output from the touch driving unit 400, and generates a touch sensing setup signal for setting the touch sensing channel through which the voltages of the touch electrodes are to be received by the touch sensing unit 410. In addition, the touch controller 420 generates timing control signals for controlling an operation timing of each of the touch driving unit 400 and the touch sensing unit 410.

The touch coordinate calculation unit 430 compares the touch raw data TRD input from the touch sensing unit 410 with a predetermined threshold value, and determines the touch raw data TRD of a predetermined threshold value or more as touch (or proximity) input data. The touch coordinate calculation unit 430 determines the touch raw data TRD of a predetermined threshold value or less as data having no touch (or proximity) input. The touch coordinate calculation unit 430 executes a preset touch coordinate calculation algorithm to calculate actual touch coordinates (hereinafter, referred to as “touch coordinates”), each of which is a coordinate for each of pieces of the touch raw data TRD determined as the touch (or proximity) input data. The touch coordinate calculation algorithm may be implemented with any known algorithm.

The touch coordinate correction unit 440 corrects each of the touch coordinates calculated by the touch coordinate calculation unit 430 to calculate an output coordinate to be displayed on the display panel 210. The touch coordinate correction unit 440 may transmit the corrected touch coordinates to the host system 250 according to a predetermined touch coordinate transmission frequency. In one embodiment, the transmission frequency at which the corrected touch coordinates are transmitted may be changed on the basis of a touch speed or the like.

To this end, as illustrated in FIG. 4, the touch coordinate correction unit 440 according to the present disclosure includes a predicted coordinate calculator 442, a corrected coordinate calculator 444, and an output coordinate calculator 446.

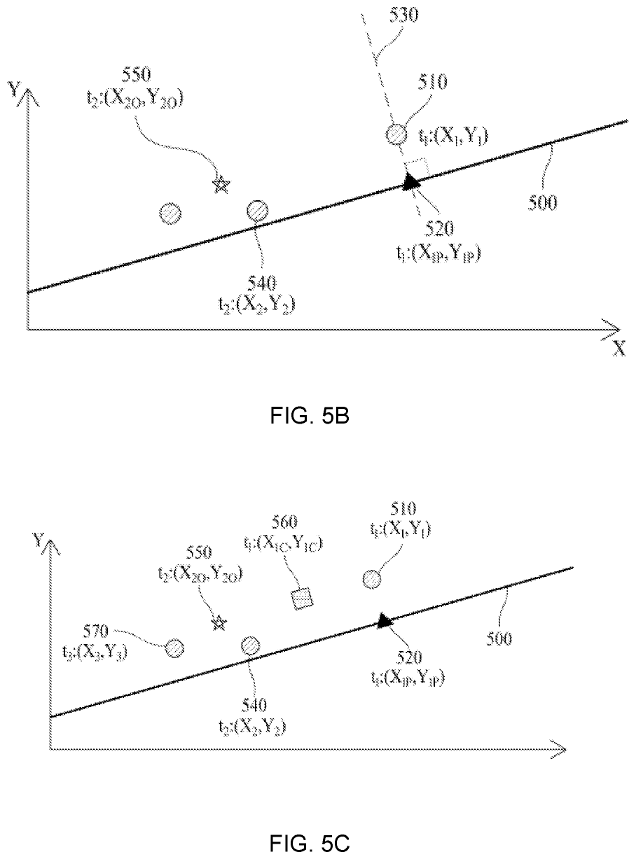

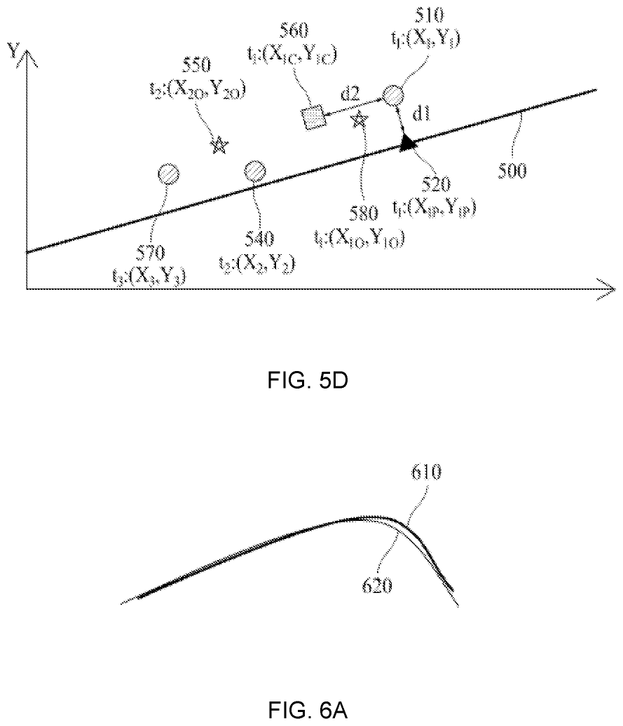

The predicted coordinate calculator 442 calculates a trend line on the basis of a plurality of past touch coordinates calculated by the touch coordinate calculation unit 430 and calculates a first predicted coordinate for a first touch coordinate of a first time point, which is a current time point, using the calculated trend line. Here, the predicted coordinate calculator 442 may calculate a trend line in the form of a linear function, that is, a straight trend line, using a plurality of touch coordinates generated before the first time point. For example, as illustrated in FIG. 5A, the predicted coordinate calculator 442 may calculate a trend line 500 in the form of a linear function using a plurality of touch coordinates 495 generated before a first time point t1.

According to the embodiment, when a predetermined number of touch coordinates are calculated by the touch coordinate calculation unit 430, the predicted coordinate calculator 442 may calculate a trend line using the calculated touch coordinates. Alternatively, when a predetermined time has passed after the touch coordinates are first calculated, the predicted coordinate calculator 442 may calculate the trend line using touch coordinates calculated during the corresponding time.

In one embodiment, the predicted coordinate calculator 442 may calculate the trend line 500 in the form of a linear function from the plurality of touch coordinates 495 before the first time point t1 using a least-squares method.

According to the above-described embodiment, the predicted coordinate calculator 442 may calculate a coordinate of a point at which a first touch coordinate 510 is mapped on the trend line 500 in the form of a linear function as the first predicted coordinate. In one embodiment, as illustrated in FIG. 5B, the predicted coordinate calculator 442 may calculate a coordinate 520 of a point having a minimum distance from the first touch coordinate 510 among points on the trend line 500 in the form of a linear function as a first predicted coordinate 520. In this case, as illustrated in FIG. 5B, an X-coordinate value of the first predicted coordinate 520 may be expressed as X_{1P}, and a Y-coordinate value of the first predicted coordinate 520 may be expressed as Y_{1P}.

To this end, the predicted coordinate calculator 442 may calculate a coordinate of a point, at which a virtual straight line 530 passing through the first touch coordinate 510 perpendicularly intersects the trend line 500, as the first predicted coordinate 520.

As described above, according to the present disclosure, since the coordinate of the point at which the first touch coordinate is matched on the virtual trend line calculated using the least-squares method is calculated as the first predicted coordinate, the first predicted coordinate is positioned outward than the actually drawn touch line, so that, when drawing a curved line, a phenomenon in which the touch line displayed with the corrected touch coordinates is drawn inward than the actually drawn touch line may be prevented.

Referring to FIG. 4 again, the corrected coordinate calculator 444 corrects the first touch coordinate to calculate a first corrected coordinate. In more detail, as illustrated in FIG. 5C, the corrected coordinate calculator 444 corrects the first touch coordinate 510 using a reference coordinate 550 and the first touch coordinate 510, thereby calculating a first corrected coordinate 560. Here, the reference coordinate 550 is calculated on the basis of a second touch coordinate 540 at a second time point t2 before the first time point t1. In this case, an X-coordinate value of the first corrected coordinate 560 may be expressed as X_{1C}, and a Y-coordinate value of the first corrected coordinate 560 may be expressed as Y_{1C}.

In one embodiment, the corrected coordinate calculator 444 may calculate the first corrected coordinate 560 by applying smoothing technique to the reference coordinate 550 and the first touch coordinate 510. That is, the corrected coordinate calculator 444 may calculate the first corrected coordinate 560 by summing resultant values each obtained by multiplying each of the reference coordinate 550 and the first touch coordinate 510 by a predetermined weight. In one embodiment, the weight to be multiplied by each of the reference coordinate 550 and the first touch coordinate 510 may be set within a range in which the sum of the weights equals to one. In this case, the weight to be multiplied by each of the reference coordinate 550 and the first touch coordinate 510 may be set to the same value, but may be set to a different value.

In the above-described embodiment, the reference coordinate 550 may be set as a second output coordinate of the second time point t2. That is, the reference coordinate 550 may be set as the second output coordinate that is finally output on a display at the second time point t2 before the first time point t1.

In the above-described embodiment, the reference coordinate 550 is described as being set as the second output coordinate of the second time point. However, in another embodiment, in a case in which a second predicted coordinate required for calculating the second output coordinate cannot be calculated at the second time point, the corrected coordinate calculator 444 may set the second touch coordinate 540 itself as the reference coordinate, or may also set a coordinate obtained by applying smoothing technique to a third touch coordinate 570 of a third time point t3 before the second time point t2 and the second touch coordinate 540 as the reference coordinate. Here, an example of the case in which the second predicted coordinate cannot be calculated may be a case in which the number of touch coordinates required for calculating the trend line at the second time point is less than a reference value and thus the predicted coordinate calculator 442 cannot calculate the second predicted coordinate of the second time point t2 and the trend line.

Referring to FIG. 4 again, the output coordinate calculator 446 calculates a first output coordinate of the first time point using the first predicted coordinate calculated by the predicted coordinate calculator 442 and the first corrected coordinate calculated by the corrected coordinate calculator 444. That is, as illustrated in FIG. 5D, a first output coordinate 580 at the first time point t1 is calculated using the first predicted coordinate 520 and the first corrected coordinate 560. The first predicted coordinate 520 is calculated based on the first touch coordinate 510, and the first corrected coordinate 560 is calculated based on the first touch coordinate 510 and the reference coordinate 550. In this case, an X-coordinate value of the first output coordinate 580 may be expressed as X_{1O}, and a Y-coordinate value of the first output coordinate 580 may be expressed as Y_{1O}.

In one embodiment, the output coordinate calculator 446 may calculate the first output coordinate 580 of the first time point t1 by summing a value obtained by multiplying each of the X- and Y-coordinate values of the first predicted coordinate 520 by a first weight W1 and a value obtained by multiplying the X- and Y-coordinate values of the first corrected coordinate 560 by a second weight W2, as described in Equation 1 and Equation 2 below,

X_{1O}=W₁X_{1P}+W₂X_{1C} [Equation 1]

Y_{1O}=W₁Y_{1P}+W₂Y_{1C} [Equation 2]

where X_{1O} denotes the X-coordinate value of the first output coordinate 580, Y_{1O} denotes the Y-coordinate value of the first output coordinate 580, X_{1P} denotes the X-coordinate value of the first predicted coordinate 520, Y_{1P} denotes the Y-coordinate value of the first predicted coordinate 520, X_{1C} denotes the X-coordinate value of the first corrected coordinate 560, and Y_{1C} denotes the Y-coordinate value of the first corrected coordinate 560.

In the above-described embodiment, the output coordinate calculator 446 may calculate an average value of a distance d1 between the first predicted coordinate 520 and the first touch coordinate 510 and a distance d2 between the first corrected coordinate 560 and the first touch coordinate 510 and calculate the calculated average value as the first weight and the second weight.

The output coordinate calculator 446 transmits the first output coordinate 580 of the first time point to the host system 250, and thus the output coordinates of every time point are connected and drawn as one touch line on the display panel 210 by the host system 250.

The reason why the output coordinate calculator 446 does not determine the output coordinates using only the predicted coordinates is that, when the drawn touch line is corrected using only the predicted coordinates calculated based on the least-squares method, the trajectory of the corrected touch line is drawn to be greater than that of the actually drawn touch line when drawing a curved line.

Further, when the output coordinate calculator 446 according to the present disclosure calculates the output coordinate using a sum of a weighted coordinate at a center point of the touch coordinates of the past time points and a weighted predicted coordinate instead of using the corrected coordinates that are calculated using the smoothing technique, similar to the case of correcting the touch line using only the predicted coordinates described above, there is still a disadvantage in that the trajectory of the corrected touch line is drawn to be greater than the trajectory of the actually drawn touch line when drawing a curved line.

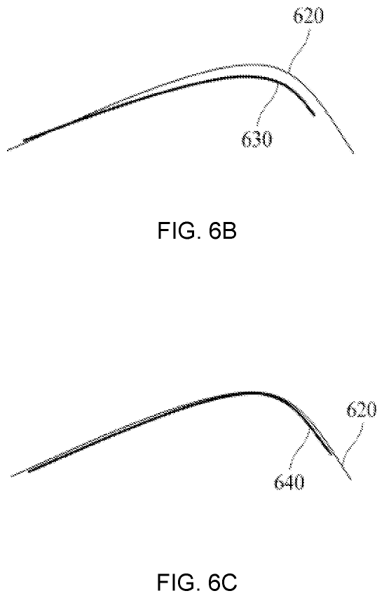

In consideration of this, the output coordinate calculator 446 according to the present disclosure calculates the output coordinate using a sum of the weighted predicted coordinate, which is based on the least-squares method causing a corrected touch line 610 to be drawn outward than an actual touch line 620 as illustrated in FIG. 6(a), and a weighted corrected coordinate, which is based on the smoothing technique causing a corrected touch line 630 to be drawn inward than the actual touch line 620 as illustrated in FIG. 6(b). Accordingly, opposite properties of the predicted and corrected coordinates are offset, so that a corrected touch line 640 may be drawn to be very close to the actually drawn touch line 620.

The touch coordinate calculation unit 430 and the touch coordinate correction unit 440, which are described above, may be implemented as a microcontroller unit (MCU).

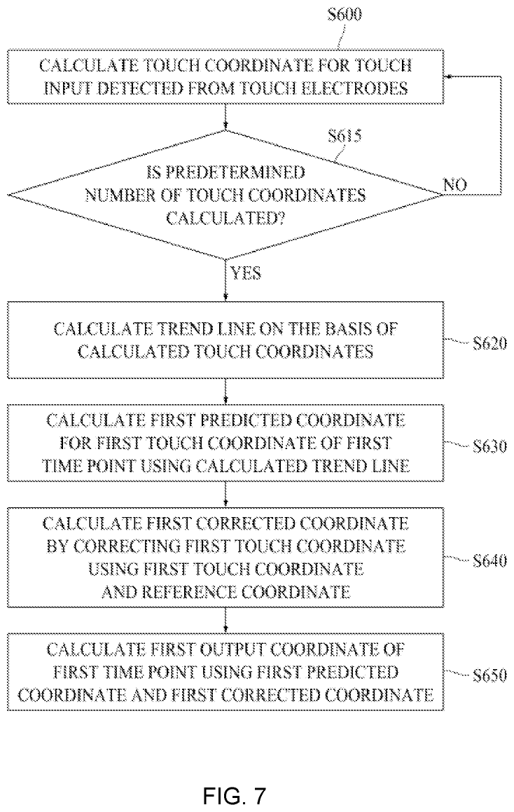

Hereinafter, a touch sensing method for reducing jitter according to the present disclosure will be described with reference to FIG. 7. FIG. 7 is a flowchart illustrating a touch sensing method for reducing jitter according to one embodiment of the present invention. The touch sensing method illustrated in FIG. 7 may be performed by the touch sensing device illustrated in FIG. 4.

First, a touch sensing device calculates touch coordinates for touch inputs detected from touch electrodes (S600). The touch sensing device calculates the touch coordinates, each of which is a coordinate for each of pieces of touch raw data TRD determined as touch input data, by executing a preset touch coordinate calculation algorithm. Here, the touch coordinate calculation algorithm may be implemented with any known algorithm.

Thereafter, when a predetermined number of touch coordinates are calculated by the touch sensing device (S615), the touch sensing device calculates a trend line on the basis of the calculated touch coordinates (S620). In the above-described embodiment, it is described that, when a predetermined number of touch coordinates are calculated, the touch sensing device calculates the trend line using the calculated touch coordinates, but in another embodiment, the touch sensing device may calculate the trend line on the basis of touch coordinates calculated for a predetermined time.

In one embodiment, the touch sensing device may calculate the trend line in the form of a linear function, that is, the trend line in the form of a straight line. According to the embodiment, the touch sensing device may calculate the trend line in the form of a linear function from the plurality of touch coordinates using a least-squares method.

Meanwhile, when the predetermined number of touch coordinates is not obtained by the touch sensing device in the operation S615, the touch sensing device continuously obtains the touch coordinates until the predetermined number of touch coordinates are obtained in the operation S610.

Thereafter, the touch sensing device calculates a first predicted coordinate for a first touch coordinate of a first time point using the trend line calculated in the operation S620 (S630). In more detail, the touch sensing device may calculate a coordinate of a point at which the first touch coordinate is mapped on the trend line calculated in the operation S520 as a first predicted coordinate. In one embodiment, the touch sensing device may calculate a coordinate of a point having a minimum distance from the first touch coordinate among points on the trend line, that is, a coordinate of an intersection point when a line is drawn to be perpendicular to the trend line from the first touch coordinate as the first predicted coordinate.

Afterward, the touch sensing device calculates a first corrected coordinate by correcting the first touch coordinate using the first touch coordinate and a reference coordinate (S640). In more detail, the touch sensing device may calculate the first corrected coordinate by applying a smoothing technique to the first touch coordinate and the reference coordinate to correct the first touch coordinate.

In one embodiment, the reference coordinate may be set as a second output coordinate of a second time point. That is, the reference coordinate may be set as the second output coordinate that is finally output on a display at the second time point before the first time point.

In the above-described embodiment, the reference coordinate is illustrated as being set as the second output coordinate of the second time point. However, in another embodiment, in a case in which a second predicted coordinate required for calculating the second output coordinate cannot be calculated at the second time point, for example, in a case in which the number of touch coordinates required for calculating the trend line at the second time point is less than a reference value and thus the trend line and the second predicted coordinate of the second time point cannot be calculated, a second touch coordinate itself may be set as the reference coordinate. In another embodiment, in a case in which the second predicted coordinate required for calculating the second output coordinate cannot be calculated at the second time point, a coordinate, which is obtained by applying smoothing technique to a third touch coordinate of a third time point before the second time point and the second touch coordinate may be set as the reference coordinate.

Thereafter, the touch sensing device calculates the first output coordinate of the first time point using the first predicted coordinate calculated in the operation S630 and the first corrected coordinate calculated in the operation S640 (S650). In one embodiment, the touch sensing device may calculate the first output coordinate by summing a value obtained by multiplying the first predicted coordinate by a first weight and a value obtained by multiplying the first corrected coordinate by a second weight. Here, the first and second weights may be calculated using an average value of a distance between the first predicted coordinate and the first touch coordinate and a distance between the first corrected coordinate and the first touch coordinate.

In FIG. 7, for convenience of description, it is described that the touch sensing device calculates the first predicted coordinate first and then calculates the first corrected coordinate, but, in another embodiment, the touch sensing device may calculate the first corrected coordinate first and then calculate the first predicted coordinate, or simultaneously calculate the first corrected coordinate and the first predicted coordinate.

Meanwhile, although not illustrated in FIG. 7, the touch sensing device may transmit the output coordinates calculated for each time point to a host system, and thus the host system may connect the output coordinates calculated for each time point to be drawn as one touch line on a display.

It should be understood by those skilled in the art that the present disclosure can be embodied in other specific forms without changing the technical concept and essential features of the present disclosure.

All disclosed methods and procedures described herein may be implemented, at least in part, using one or more computer programs or components. These components may be provided as a series of computer instructions through any conventional computer-readable medium or machine-readable medium including volatile and nonvolatile memories such as random-access memories (RAMs), read only-memories (ROMs), flash memories, magnetic or optical disks, optical memories, or other storage media. The instructions may be provided as software or firmware, and may, in whole or in part, be implemented in a hardware configuration such as application-specific integrated circuits (ASICs), field-programmable gate arrays (FPGAs), digital signal processors (DSPs), or any other similar device. The instructions may be configured to be executed by one or more processors or other hardware configurations, and the processors or other hardware configurations are allowed to perform all or part of the methods and procedures disclosed herein when executing the series of computer instructions.

According to the present disclosure, a predicted coordinate for a current touch coordinate is calculated on the basis of a trend line calculated on the basis of a plurality of touch coordinates, and a final output coordinate for the current touch coordinate is calculated using a sum of a weighted reference coordinate, which is calculated on the basis of past touch coordinates and a weighted predicted coordinate so that jitter of a drawn touch line can be reduced, and simultaneously, an adhesion feeling of a touch can be improved.

Further, according to the present disclosure, since a trend line is calculated using a least-squares method, a predicted coordinate determined based on the trend line is located outward than an actually drawn touch line so that there is an effect in which a touch line drawn with final output coordinates, which is calculated by summing the weighted predicted coordinate and the weighted reference coordinate, can be drawn to be very close to the actually drawn touch line.

Therefore, the above-described embodiments should be understood to be exemplary and not limiting in every aspect. The scope of the present disclosure will be defined by the following claims rather than the above-detailed description, and all changes and modifications derived from the meaning and the scope of the claims and equivalents thereof should be understood as being included in the scope of the present disclosure.

What is claimed is:

1. A touch sensing device for reducing jitter, the touch sensing device comprising:
a touch coordinate calculation unit configured to calculate a touch coordinate for a touch input detected from touch electrodes; and
a touch coordinate correction unit configured to calculate an output coordinate to be displayed on a display by correcting the touch coordinate calculated by the touch coordinate calculation unit,
wherein the touch coordinate correction unit includes:
a predicted coordinate calculator configured to calculate a trend line on the basis of touch coordinates before a first time point and calculate a coordinate of a point, at which a first touch coordinate at the first time point is mapped on the trend line, as a first predicted coordinate of the first time point;
a corrected coordinate calculator configured to calculate a first corrected coordinate by correcting the first touch coordinate using the first touch coordinate and a reference coordinate that is calculated on the basis of a second touch coordinate at a second time point before the first time point; and
an output coordinate calculator configured to calculate a first output coordinate of the first time point using the first predicted coordinate and the first corrected coordinate.

2. The touch sensing device of claim 1, wherein the predicted coordinate calculator calculates a coordinate of a point, which has a minimum distance from the first touch coordinate, among points on the trend line as the first predicted coordinate.

3. The touch sensing device of claim 1, wherein the predicted coordinate calculator calculates the trend line in a form of a linear function from the touch coordinates before the first time point using a least-squares method.

4. The touch sensing device of claim 1, wherein the output coordinate calculator calculates the first output coordinate by summing a first resultant value obtained by multiplying the first predicted coordinate by a first weight and a second resultant value obtained by multiplying the first corrected coordinate by a second weight.

5. The touch sensing device of claim 4, wherein the output coordinate calculator calculates an average value of a distance between the first predicted coordinate and the first touch coordinate and a distance between the first corrected coordinate and the first touch coordinate as the first and second weights.

6. The touch sensing device of claim 1, wherein the corrected coordinate calculator applies smoothing technique to the reference coordinate and the first touch coordinate to calculate the first corrected coordinate.

7. The touch sensing device of claim 1, wherein the reference coordinate is a second output coordinate at the second time point.

8. The touch sensing device of claim 1, wherein, when the number of touch coordinates required for calculating the trend line at the second time point is less than a reference value, the reference coordinate is set as the second touch coordinate, or set as a coordinate obtained by applying smoothing technique to the second touch coordinate and a third touch coordinate at a third time point before the second time point.

9. The touch sensing device of claim 1, wherein output coordinates calculated for each time point are drawn as one line on a display.

10. A touch sensing method for reducing jitter, the method comprising:
calculating a trend line on the basis of touch coordinates generated before a first time point;
calculating a coordinate of a point at which a first touch coordinate at the first time point is mapped on the trend line as a first predicted coordinate of the first time point;
calculating a first corrected coordinate by correcting the first touch coordinate using a reference coordinate and the first touch coordinate, the reference coordinate being calculated on the basis of a second touch coordinate of a second time point before the first time point; and
calculating a first output coordinate at the first time point using the first predicted coordinate and the first corrected coordinate.

11. The method of claim 10, wherein, in the calculating of the coordinate as the first predicted coordinate, a coordinate of a point, which has a minimum distance from the first touch coordinate, among points on the trend line is calculated as the first predicted coordinate.

12. The method of claim 10, wherein, in the calculating of the coordinate as the first predicted coordinate, the trend line in a form of a linear function is calculated from the plurality of touch coordinates using a least-squares method.

13. The method of claim 10, wherein, in the calculating of the first output coordinate, the first output coordinate is calculated by summing a value obtained by multiplying the first predicted coordinate by a first weight and a value obtained by multiplying the first corrected coordinate by a second weight.

14. The method of claim 13, wherein each of the first and second weights is an average value of a distance between the first predicted coordinate and the first touch coordinate and a distance between the first corrected coordinate and the first touch coordinate.

15. The method of claim 10, wherein, in the calculating of the first corrected coordinate, the first corrected coordinate is calculated by applying smoothing technique to the reference coordinate and the first touch coordinate.

16. The method of claim 10, wherein the reference coordinate is set as a second output coordinate at the second time point.

17. The method of claim 10, wherein, when the number of touch coordinates required for calculating the trend line at the second time point is less than a reference value, the reference coordinate is set as the second touch coordinate or set as a coordinate obtained by applying smoothing technique to the second touch coordinate and a third touch coordinate at a third time point before the second time point.

18. The method of claim 10, further comprising connecting output coordinates calculated for each time point to be drawn as one touch line on a display.
